(19) United States
(12) Patent Application Publication
(10) Pub. No.: US 2002/0164102 A1
(43) Pub. Date: Nov. 7, 2002

(54) Tapered journal bearings

(76) Inventor: William F. Kurtz, Stony Point, NY (US)

Correspondence Address: ALLEN N. FRIEDMAN, ESQ., C/O MCCARTER & ENGLISH, LLP, FOUR GATEWAY CENTER, 100 MULBERRY STREET, NEWARK, NJ, 07102, US

(21) Appl. No.: 10/107,280

(22) Filed: Mar. 26, 2002

Related U.S. Application Data
(60) Provisional application No. 60/280,652, filed on Mar. 30, 2001.

(51) Int. Cl. F16C 33/58

(52) U.S. Cl. 384/571

(57) ABSTRACT

The disclosed F-Class and K-Class Railroad car wheel bearings employ 24 rollers per cone assembly to meet increasing load and service life objectives.

### RELATED APPLICATIONS

This Application claims priority from Provisional Application Ser. No. 60/280,652, filed Mar. 30, 2001.

### GOVERNMENT FUNDED RESEARCH

Not applicable

### BACKGROUND OF THE INVENTION

1. Field of the Invention

The invention is in the field of wheel bearings.

2. Summary of the Background Art

The Rail industry has been driving improvements to freightcar components in the area of increased life and increased capacity. The freightcar's capacity is based on the size of the bearing mounted on each end of the car's wheel-axle assemblies. The most popular size, as classified by the Association of American Railroads, is the AAR's F-Class bearing. The existing product is what is called a cone assembly used in bearings that, for example, support axles of railroad freight cars. The existing cone assembly consists of three components assembled together. They are known as the cone (or inner ring), the rollers (23 per assembly) and the roller retainer. In the railroad industry this cone assembly is also known as the A.A.R. Class F cone assembly, the 6½×12 cone assembly, and is identified by part number by most manufacturers including General Bearing as HM133444.

The F-Class bearing was originally required to support a total car weight of 268,000 pounds. Approximately 10,800 pounds of the 268,000 pounds, attributed to the weight of the 4 axles and 8 wheels, is not supported by the bearing. So each bearing will see a load in the non-moving static condition of 32,150 pounds. At some point, after testing and other evaluations, the AAR allowed the load of Class F service to increase to 286,000 pounds or 34,400 pounds per bearing. This increase greatly improved the economics of bulk product movement. Unfortunately, it started to put a strain on the bearing life.

In the moving or dynamic state, the bearings can see much higher loads in cornering situations and in similar application conditions. Varying track conditions and wheel conditions due to wear will also expose the bearings to shock loads. With the increased load to 286,000 pounds the failure rate of the bearings increased. Some bearing manufacturer's approached this problem by trying to increase the system stiffness. A new bearing was developed called the Class K bearing. It is exactly the same as the Class F bearing in load capacity. This is because the rolling components of the bearing, the Outer race, Inner race, rollers, and cage are the same as the Class F bearing. The biggest difference is the length of the Outer ring which is shorter in the Class K bearing.

The short Class K bearing does not provide an increase in stiffness. The increase in stiffness is due to a shorter axle section due to the shorter bearing. The axle-bearing set-up is analogous to a cantilever beam. Because the beam is shorter and the center of the load is closer to the constrained end of the beam, less deflection occurs at the free end.

This new design has not gained widespread usage in the industry. The reason is that the car owners do not want to support inventories of two types of axles, two types of bearing adapters, and due not want to pay a premium for what should be a less expensive bearing due to the material content decrease. Further, the industry wants to go to another load level, that of 305,000 pounds per car. The Class K bearing does not have increased capacity.

### SUMMARY OF THE INVENTION

In an attempt to meet the need for increased load carrying capacity and service life, the inventive design disclosed herein breaks away from the standard 23-roller design. All manufacturers of the existing Class F bearing use a double row tapered roller bearing with 23 rollers per row. It was noted that there was a significant amount of space between the rollers, and that the roller separator ribs (sections between the rollers) were substantially wide. A new cage that would accommodate 24 rollers of the same size as the current 23 was designed. Applying the American Bearing Manufacturers Association (ABMA) standard calculation of load carrying capacity, this change produced what was calculated as a 3.4% increase to bearing capacity. This is approximately proportional to the increase in number of bearings. However, expected life calculations resulted in an unexpectedly large increase of 11.2%.

Further, the stiffness of the bearing is increased. The load transmitted through the bearing is now shared by more rollers. Any two rollers are closer together making the unsupported sections of the inner and outer race shorter and increasing the load carrying capacity. A further advantage of this bearing is that it increases the bearing capacity and bearing stiffness while allowing the user to continue to use the Class F axle and bearing adapters at the 286,000 load. When used in a Class K design, system stiffness will be further enhanced by the increased bearing stiffness. Both Class F and Class K designs should be able to support the load of 36,775 pounds required for the 305,000 pound freight car.

### BRIEF DESCRIPTION OF THE DRAWINGS

FIG. 1 is a perspective view of an exemplary item of the invention.

FIG. 2 is a plan view of an exemplary item of the invention.

FIG. 3 is an elevational view, in section, of an exemplary item of the invention.

FIG. 4 is an elevational view, in section, of an exemplary bearing assembly of the invention.

### DETAILED DESCRIPTION OF THE INVENTION

An exemplary bearing of the new design was fabricated and tested in order to see whether the advantages suggested by the calculations were actually realized. The design and building of a test rig for this bearing provided a great number of challenges. Because of the heavy loads required and the significant speeds that were needed to test at, the frame needed to be fabricated from heavy structural steel members that were welded together. A 30 hp electrical motor was required to turn the axle. To apply load directly to the bearings, a hydraulic system need to be employed. Heavy-duty spherical bearings were used to receive the reaction forces, to ground the axle to the frame, and to serve as a standard against which the novel bearing could be assessed. Load cells were situated between the hydraulic cylinders and the test bearings. Instruments for temperature collection on two points of each of the test bearings, one place of the spherical bearings, and the ambient air, vibrations levels and revolution counters were installed. A sophisticated motor controller with variable speed and acceleration control, and torque feedback was put in place. Tooling to mount and remove the bearings was designed and built. A computer controlled data collection system was installed.

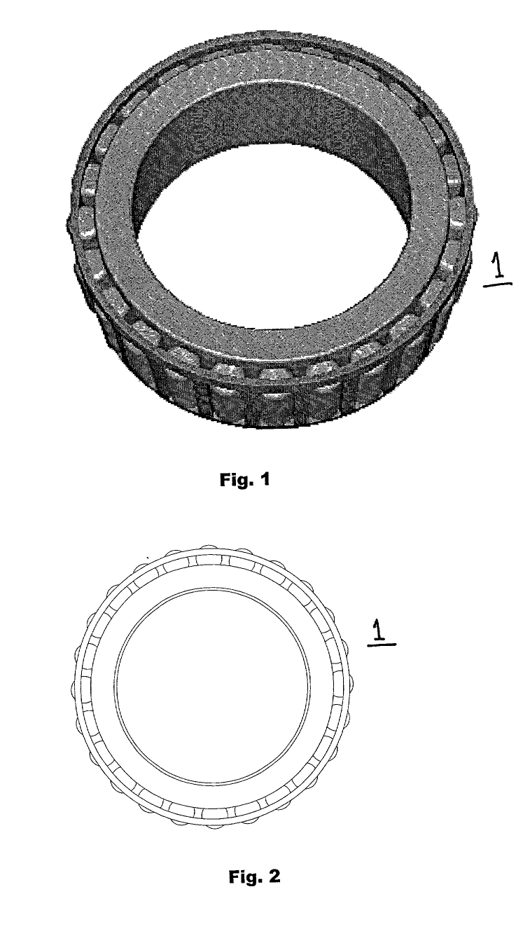

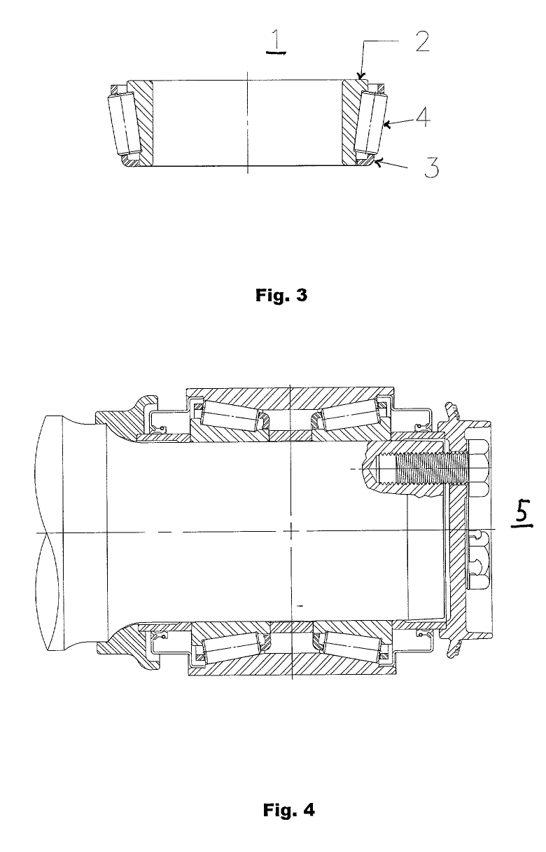

Aside from the novel 24-roller design, the test bearing was of standard design and fabricated from standard materials, to standard tolerances. FIG. 1 shows a perspective view of a 24-roller tapered journal bearing cone assembly (1) and FIG. 2 shows a plan view of that same bearing cone assembly (1). FIG. 3 shows the bearing cone assembly (1) in sectional view, illustrating the inner ring or cone (2), the roller retainer (3) (also referred to as the separator or cage), and the rollers (4). FIG. 4 shows an assembled Class-F or Class K wheel bearing (5).

Testing was commenced at relatively low speeds and loads to “break-in” the test rig. While the speed was pushed to a maximum of 70 miles per hour, we settled on a test speed of 60 miles per hour (560 rpm). Most railroads limit fully loaded freight trains to a speed of 40 miles per hour. The test ran for a total mileage of 41,664 miles before shut down to due failure of one of the spherical bearings (not the novel tapered bearings under test).

For 19,724 miles, the test bearings were run at various loads exceeding the 36,775 pounds of the 305,000 pound requirement with a maximum load of 43,105 pounds applied to the test bearings. With an 88° F. ambient temperature, the test bearings ran at a relatively cool 180° F. outer race surface temperature. All components were in good useable condition. None of the parts would have been subject to rejection based on current AAR reconditioning requirements.

The test results exceeded, in several respects, the advantages suggested by the initial calculations. The tapered journal bearings were tested for freight car service against 3 conditions: 1) known conditions for this bearing class, 2) future proposed conditions for this bearing class, and 3) against a known and proven bearing (the spherical bearing).

By being able to vary the load and speed of the test, we were able to duplicate existing applications loads and speeds for the bearing. The results were excellent as temperature and vibration levels were both lower than previous tests that were conducted at the AAR's test facility in Pueblo Colo. for the standard 23 roller bearing.

By exceeding both the speed (60 mph vs. 40 mph) and the load requirements of freightcar bearings for the proposed 305,000 pound service, it was shown that this new 24 roller bearing should meet future requirements of the freightcar industry.

The known and proven bearing was the heavy-duty spherical bearing that acted as the reaction load bearing. These spherical bearings have a catalog capacity rating of 251,000 pounds as calculated by ABMA standard 11 and listed in the catalog of their manufacturer. Our test bearing has a theoretical capacity of 214,841 pound as calculated by the same standard. Both these values are for comparison and selection of bearings and the bearings should never be expected to run at these levels but are usually classified as being under a “heavy” radial load at 18% of the dynamic capacity by ABMA definition. Although we exceeded that 18% ceiling successfully with our test bearings, the spherical bearings were not exposed to their 18% level, yet produced a failure.

These test results give great confidence that the novel 24-roller design will be a positive addition to the railroad industry by being more economical to acquire, run and maintain. By being less apt to fail, this design will also bring a higher level of safety and reliability to the industry.

I claim:

1. An AAR “F-Class” or “K-Class” wheel bearing employing a pair of tapered journal bearings, each of the tapered journal bearings consisting essentially of an inner cone, a roller retainer, and 24 rollers.
